(19) United States
(12) Patent Application Publication
(10) Pub. No.: US 2007/0071898 A1
(43) Pub. Date: Mar. 29, 2007

(54) Overspray shield

(76) Inventor: Tony Hollins, Longview, TX (US)

Correspondence Address: RONALD B. SEFRNA, P.O. BOX 567, TYLER, TX, 75710, US

(21) Appl. No.: 11/540,338

(22) Filed: Sep. 28, 2006

Related U.S. Application Data
(60) Provisional application No. 60/721,393, filed on Sep. 28, 2005.

(51) Int. Cl. B05D 1/32; B05D 7/00; B05D 1/02; B05C 11/11

(52) U.S. Cl. 427/282; 427/421.1; 118/504

(57) ABSTRACT

An overspray shield for protecting areas behind and above a structure to be sprayed includes a pair of elongate support members to be disposed in separated parallel positions behind the structure to be sprayed with the upper end of the support members extending at an angle above and forward over the structure to be sprayed, and a flexible, preferably generally rectangular shield curtain connected at two adjacent corners and a portion of the edges descending from those corners to the upper ends of the support members, with the upper portion of the shield curtain extending above and forward of the structure to be sprayed and with the remainder of the shield curtain hanging vertically behind the structure to be sprayed. In alternative embodiments the upper portion of the support members are angled, or angled brackets are connected to the support members for connection of the shield curtain.

### RELATED APPLICATION DATA

This application claims the priority benefits of U.S. Provisional Patent Application Ser. No. 60/721,393, filed Sep. 28, 2005.

### FIELD OF THE INVENTION

The present invention generally relates to shield devices and apparatus for preventing overspray of paint and other materials onto adjacent surfaces and areas, and in its preferred embodiments more specifically relates to a shield structure to be temporarily erected to protect against overspray during the washing and painting of permeable structures such as fences.

### BACKGROUND OF THE INVENTION

In both residential and commercial locations fences and walls are commonly erected along property lines, and are also commonly used within a property. Many types of fence or wall materials are painted, stained, or sealed as a part of the initial installation, and these types of fences require, or at least benefit from, periodic maintenance after installation. Many of the initial treatment and subsequent maintenance operations are most efficiently performed using spray apparatus, such as pressure washing apparatus and sprayers for paint, stain, and the like. However, the use of spray apparatus always presents a problem with fugitive spray emissions, or overspray, from the spray apparatus, to some degree. Some portion of the liquid material sprayed against a fence or wall will almost inevitably pass through or over the fence structure onto adjacent property or adjacent area. If the liquid is water the problem is often minimal, although water sprayed under high pressure may damage adjacent plants, for example. When the liquid is paint or stain the damage to adjacent areas can be significant.

Many types of fences and walls are permeable, with openings in the fence and spaces between the fence components. The degree of permeability varies, from the most permeable fence types such as chain link and other spaced wire fences, to solid structures such as brick or stone walls, which are impermeable through the fence structure itself. However, even impermeable structures are subject to overspray over the top of the fence or wall, so the use of spray apparatus with these types of structures often presents a problem.

Some attempts to alleviate this problem have been made and are known in the prior art, but the known approaches have had only limited success. There remains a substantial unfulfilled need for an effective means for protecting adjacent areas from overspray generated when spraying a liquid material against a freestanding vertical surface.

### SUMMARY OF THE INVENTION

The present invention provides a lightweight, flexible shield that is easily positioned and supported behind a freestanding vertical structure such as a fence, immediately adjacent to the face of the structure opposite the face to which a spray is to be applied. In the preferred embodiment the structure includes telescoping support members with a flexible shield curtain suspended between them. The curtain is preferably connected to the support members at their upper ends and along the portion of the support members adjacent to their upper ends, and hangs freely from the support members below the points of attachment. The support members are preferably disposed behind the structure to which a spray is to be applied at an angle to the structure, so that the upper ends of the support members and the attached portion of the curtain extend above the top of the structure and above the face of the structure at a downward angle of less than ninety degrees relative to a vertical extension of the face of the structure to be sprayed, so as to provide a shield for spray applied toward the upper edge of the structure. The remainder of the curtain hangs directly behind the structure to which a spray is to be applied, so as to provide a shield against spray which passes through openings in the structure from the face to which the spray is applied. The length of the structure may be easily adjusted for use with a short length of fence, or for use with a substantially longer section. The structure is easily collapsible for storage and transportation.

In alternative embodiments, the upper ends of the support members are offset at an angle relative to the remaining length of the poles, allowing the support members to be disposed with the majority of their length in a vertical orientation immediately behind a structure to which a spray is to be applied, with the upper portion of the support members and the attached portion of the curtain to extend at an angle above and over the face of the structure to be sprayed.

The structure and features of preferred and certain alternative embodiments of the apparatus of the invention, and the preferred method of use, will be described below with reference to the accompanying drawing figures.

### BRIEF DESCRIPTION OF THE DRAWINGS

FIG. 1 is a side elevation view of a preferred embodiment of the shield structure of the invention in place against a fence.

FIG. 2 is a front elevation view of a preferred embodiment of the shield structure in place behind a fence.

FIG. 3 is an elevation view of a preferred embodiment of a support member of the shield structure, in extended configuration.

FIG. 4 is an elevation view of a preferred embodiment of a support member, in collapsed configuration.

FIG. 5 is a perspective view of a D-clip component used for connecting the curtain component of the shield structure to a support member.

FIG. 6 is a top plan view of a snap component used in conjunction with the D-clip for connecting the curtain component to a support member.

FIG. 7 is a detail illustration of a connection between the curtain component to a support member component.

FIG. 8 is a side elevation view of the upper portion of an alternative embodiment of the support member component of the shield structure.

FIG. 9 is a side elevation view of the upper portion of a variation of the alternative embodiment shown in FIG. 8.

FIG. 10 is a side elevation view of the upper portion of another alternative embodiment of the support member component, with a removable angled curtain support component.

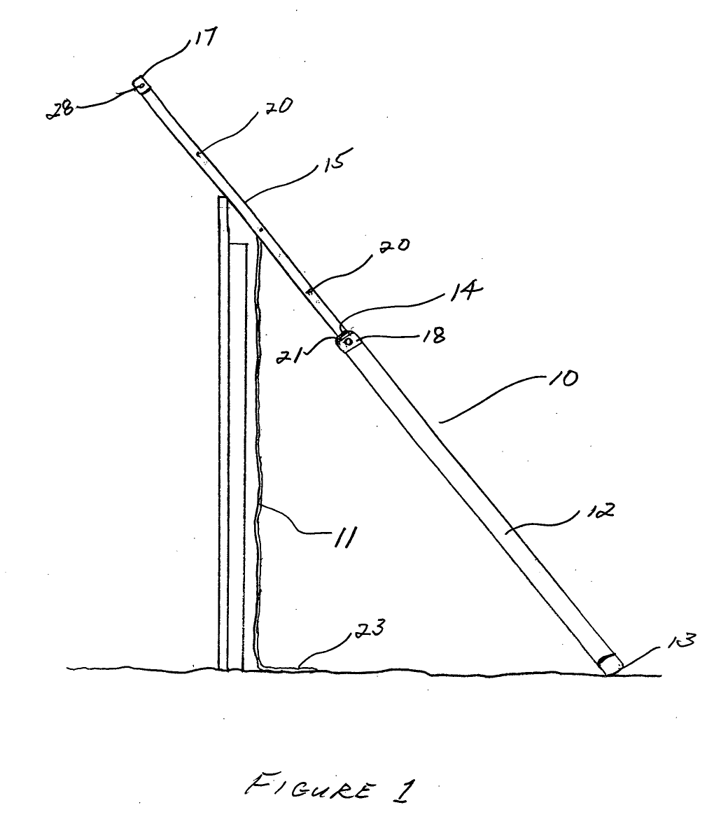

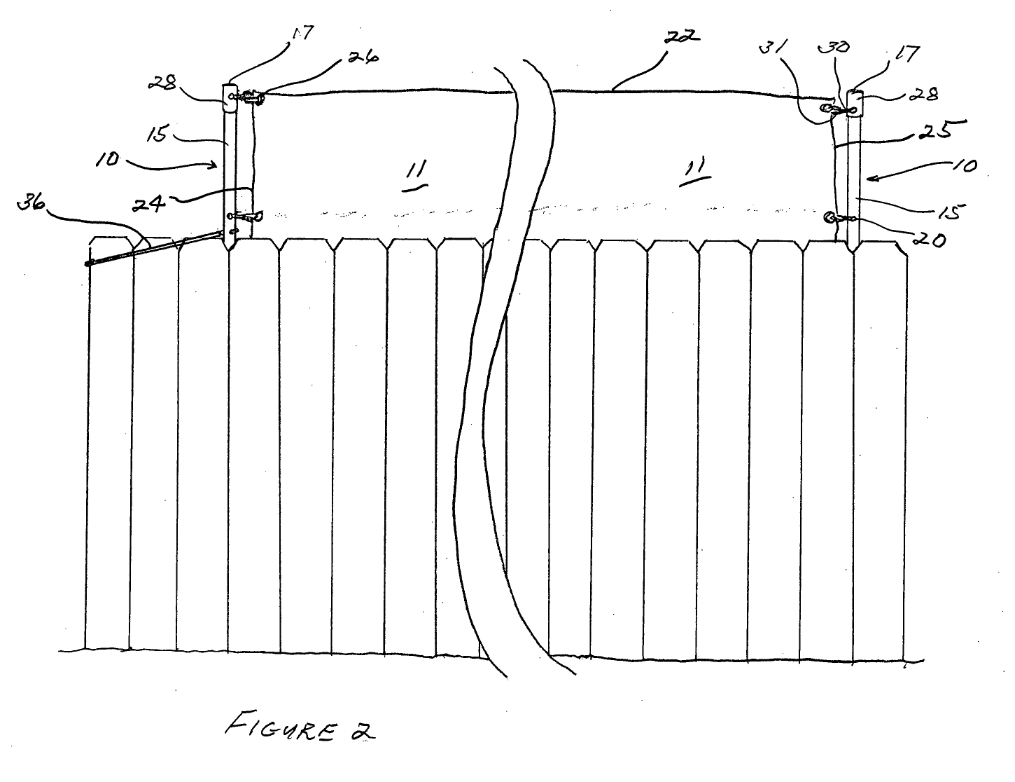

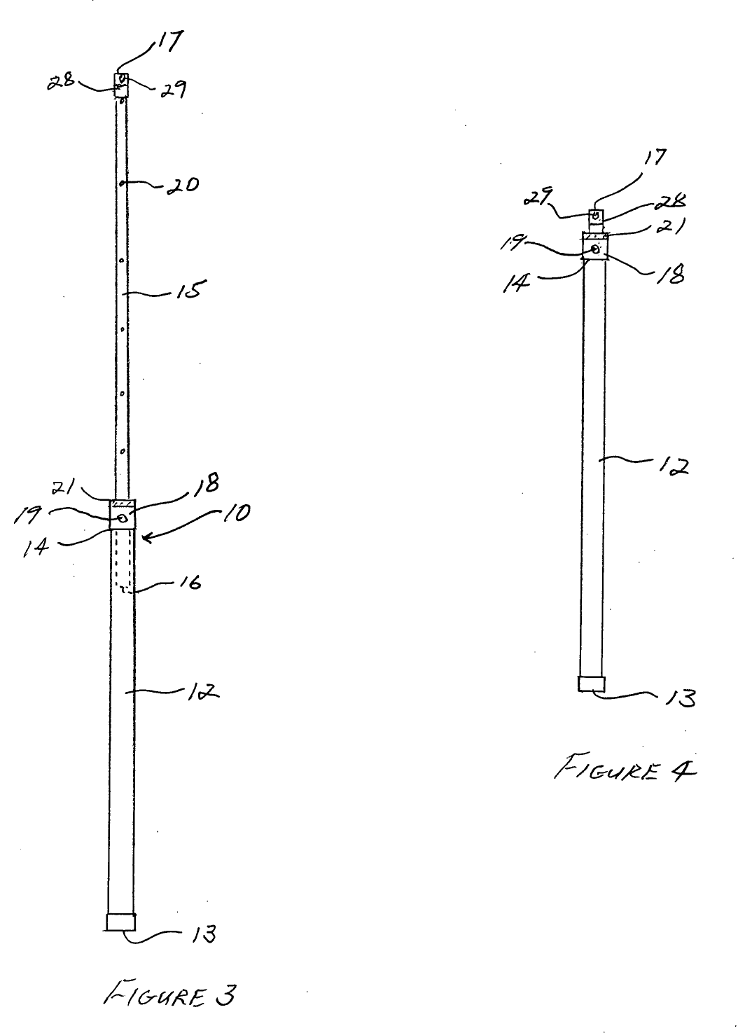

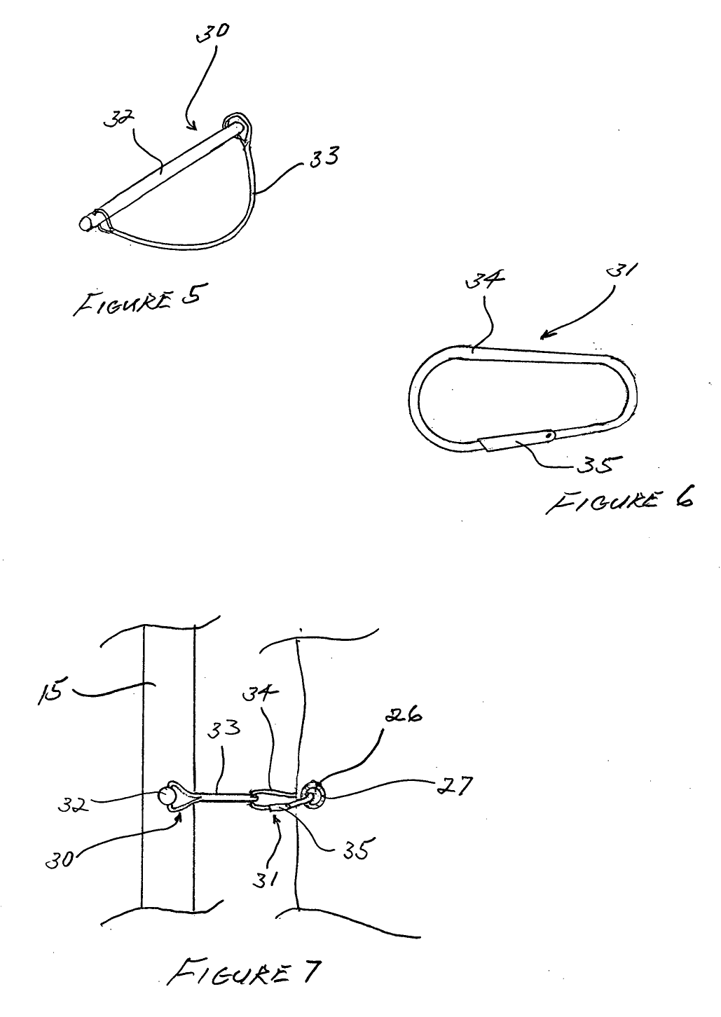

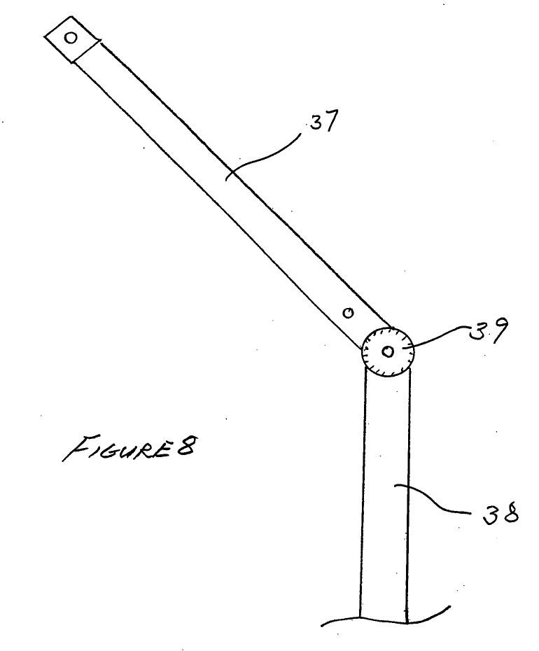

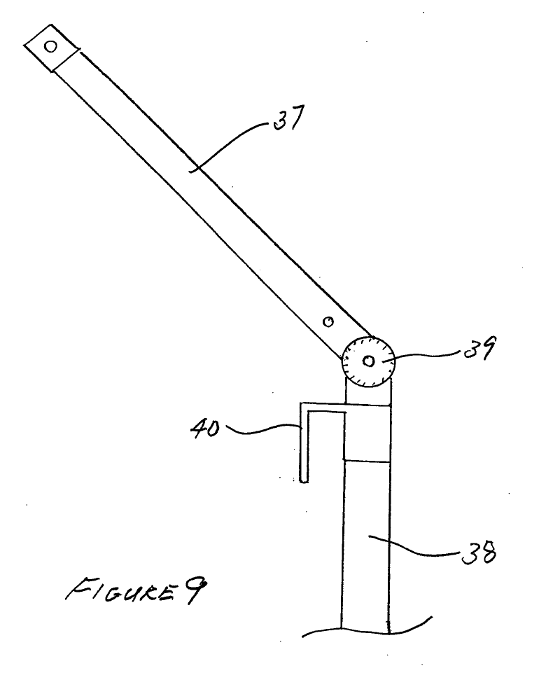

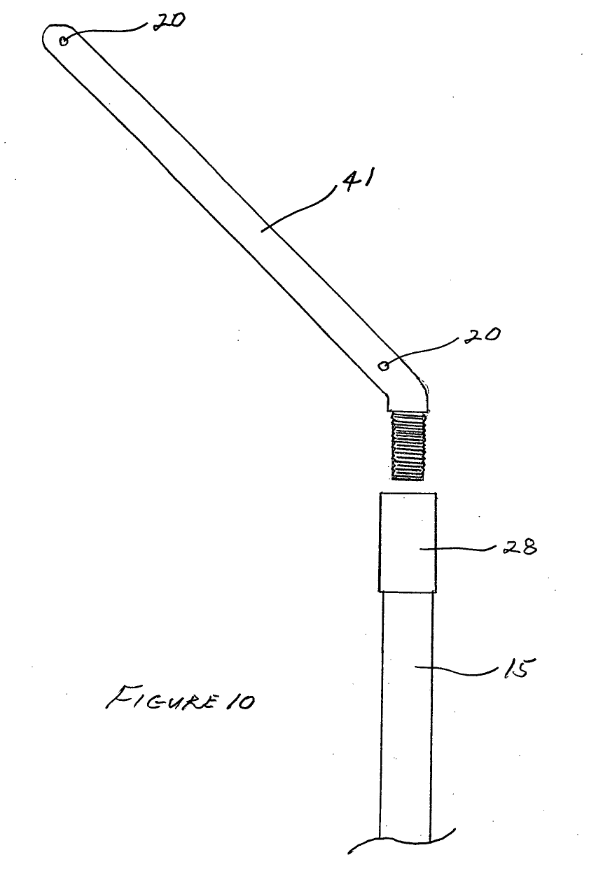

### DESCRIPTION OF THE INVENTION

The preferred embodiment of the shield structure of the invention includes, as primary components, a pair of rigid support members 10, and an elongate flexible curtain 11 which can be removably connected between support members 10.

Each support member 10 is preferably adjustable in length, and includes a first, or outer elongate hollow tube 12 with a closed first end 13 and an open second end 14, and a second, or inner elongate tube 15, slightly smaller in outside cross-sectional dimension than the inside cross-sectional dimension of the first tube. The first end 16 of inner tube 15 extends into the interior of outer tube 12 through its second end 14 in adjustable telescoping relation. Inner tube 15 is preferably of slightly greater length than outer tube 12, so that the second end 17 of tube 15 extends outwardly from the first tube when the tubes are fully telescoped together.

A locking assembly 18, disposed at the second, upper end 14 of outer tube 12 releasably locks inner tube 15 relative to the outer tube 12, for adjusting the overall length of the support members. In the preferred embodiment locking assembly 18 includes a spring-loaded pin 19 that extends into a selected one of a plurality of apertures 20 disposed along the length of inner tube 15 to lock the position of tube 15 relative to tube 12. The adjustability of the overall length of each support member is incremental and determined by the spacing between apertures 20. The positive lock formed between the two tubes by extending a pin in a selected aperture is preferred in order to assure that the inner tube does not slip into the outer tube during use, which would result in a partial collapse of the support member. It is to be understood, however, that the specific structure of the locking assembly is not critical the invention, and alternative locking assembly, such as but not limited to a threaded compression ring mechanism, may be used within the scope of the invention. Even if an alternative locking assembly is used, apertures 20 are not omitted, because those apertures serve a purpose in the connection of curtain 11 to support members 10, described below.

It is also preferred that inner tube 15 be non-circular in cross-sectional configuration, and that locking assembly 18 include a generally annular guide ring 21 of the same inside configuration as the outside configuration of tube 15 to prevent rotation of tube 15 relative to tube 12 during extension and retraction of tube 15 and maintain the alignment of apertures 20 with pin 19 to facilitate adjustment. This feature, though preferred, is not critical to the invention, and any tube configuration that enables longitudinal movement and adjustability may be used.

Curtain 11 is a preferably rectangular flexible sheet, with an upper edge 22, a lower edge 23, and side edges 24 and 25. A plurality of apertures 26 are disposed in spaced relation along both side edges 24 and 25, and are preferably reinforced by grommets 27. One of apertures 26 is disposed adjacent to the corner formed by the intersection of side edge 24 and upper edge 22, and another aperture is disposed at the corner between edges 25 and 22. The spacing between apertures 26 along the side edges and the spacing between apertures 20 in tube 15 is preferably equal or at least approximately equal.

In the preferred embodiment curtain 11 is formed of a fiber reinforced plastic material, such as but not limited to the material commonly used for light plastic tarpaulins. The material of construction of curtain 11 is preferably relatively light in weight, to facilitate positioning and moving the shield structure, but with sufficient weight to restrain movement of the curtain by wind and prevent the curtain from flapping or billowing in a light wind when erected for use. A conventional plastic tarpaulin, which are readily commercially available in a variety of sizes, is well suited for use as curtain 11. It is to be understood, however, that the material of construction of cover 11 is not critical, and a wide range of materials that will resist penetration by a liquid spray could be used within the scope of the invention.

To prepare the overspray shield structure of the invention for use, the support members 10 are at least partially extended by releasing locking assembly 18 and sliding tubes 15 outward from tubes 12, and the upper portions of side edges 24 and 25 of curtain 11, adjacent to upper edge 22, are releasably connected to the upper portions of tube 15 of two support members. One of the connections between curtain 11 and each of the support members is between the upper ends 17 of tubes 15 and the upper apertures 26, at the corners of the side edges and upper edge 22 of curtain 11. In the preferred embodiment, each of tubes 15 includes a collar 28 with a connector aperture 29 at upper end 17, closing upper end 17 and providing for connection of curtain 11 so that the upper edge of curtain 11 is generally aligned with the upper ends of tubes 15. This structure is not critical, however, and another approach, such as connecting the upper corners of curtain 11 to apertures 20 near the upper ends of tubes 15, could be used for the upper connection of curtain 11 to the support members. In addition to the connection between the upper corners of curtain 11 and the support members, one or two additional connections is made between each side edge and the respective tube 15 of the support members. Regardless of the number of connections made, only the upper portions of side edges 24 and 25 are connected to the support members, and the majority of the length of the side edges remains free from connection to a support member.

In the preferred embodiment the connections between curtain 11 and tubes 15 of the support members is made using a D-clip 30 and a snap 31 for each connection. D-clips 30 include a pin 32 and a curved spring retainer 33 pivotally connected to pin 32 at one end and adapted to releasably engage pin 32 at the opposite end. Snaps 31 are formed with a curved body 34 around a hollow interior area, with a spring loaded gate 35 between the ends of the body. In the preferred method of attaching curtain 11 to tubes 15, two D-clips are connected to tube 15 of each of two support members 10, by extending pin 32 of one clip through connector aperture 29 at the end of tube 15, and pin 32 of a second clip through the aperture 20 that is spaced from connector aperture 29 the same distance between the aperture 26 at an upper corner of curtain 11 and the next adjacent aperture 26 along the side edge of the curtain, and then closing retainers 33 to close the D-clips. A snap 31 is connected in the aperture 26 at the upper corner of each side of curtain 11, and in the next adjacent aperture 26. Snaps 31 are then connected to D-clips 30, to secure the upper portion of each side edge of curtain 11 to the upper portion of each support member.

The shield structure of the invention is used by positioning it on the side of, e.g., a fence, opposite the side against which a spray is to be directed. Support members 10 are separated along the fence to pull the upper portion of curtain 11, along and adjacent to upper edge 22, relatively tight between the supports. The upright supports are positioned at an angle relative to the vertical fence, or other structure, and the length of the upright supports is adjusted so that the lower point of attachment between the support members and curtain 11 is approximately aligned with, or slightly below, the top of the fence. The telescoping design of the support members allows the length of each support member to be adjusted to compensate for slopes and uneven ground surfaces so that the curtain can be properly positioned regardless of terrain. The upper portion of the support members and the portion of curtain 11 connected between them extend above the top of the fence and overhang the side to be sprayed at an upward angle. Because the remainder of curtain 11 is not connected to the support members, that unconnected portion will hang vertically directly behind the fence.

In some situations the fence structure itself may be used to retain upright members 10 and maintain some tension on the portion of curtain 11 connected between them. In other situations the fence structure does not provide suitable anchor points for the upright members, and elastic cords 36, or other suitable separating means, may be used to maintain the separation of the support members. One end of an elastic cord is connected to each support member 10, generally at the location of the lower connection of curtain 11, the cord is stretched outwardly from the support member and curtain, and connected to the fence structure at its opposite end.

The vertical portion of curtain 11 provides a shield immediately behind the fence, so that any sprayed material that penetrates the fence structure, such as between boards of a wood plank fence or between lath strips of a lattice fence, will be stopped by the portion of curtain 11 disposed immediately behind the fence. If, for example, shrubbery or other plants, are in place adjacent to the fence, the vertical portion of the curtain may easily positioned between the plants and the fence to provide a protective barrier against overspray. Sprayed material, even from a high pressure sprayer, that passes through the fence structure will be stopped by the hanging curtain before any of the material comes into contact with adjacent plants or other structures.

The overhanging portion of curtain 11 that is connected between the upper portions of the support members forms an overhead barrier against overspray above the top of the fence. Spray that is directed at or even above the top of the fence will be blocked by the overhanging barrier and prevented from passing over the top of the fence onto adjacent plants or structures, or upward into the air.

When the spraying operation is completed in the section of fence protected by the shield, the shield structure can be easily moved along the fence to shield another section and allow the spraying operation to continue with little interruption. When the spraying operation is fully completed the shield structure of the invention may be easily and quickly removed and disassembled for storage, by reversing the steps of the set-up sequence. The telescoping support members of the preferred embodiment may be collapsed to reduce their length for easier storage and transportation, and the curtain may be folded or rolled for storage.

The overspray shield structure of the invention is susceptible to various alternative embodiments and variations in addition to the preferred embodiment described above. As a non-limiting example, other means of connecting the curtain to the support members may be utilized as an alternative to the described D-clips and snaps, so long as the alternative means maintain an appropriate spacing between the attachment points. The clips and snaps of the preferred embodiment allow some variation in the spacing between attachment points on the support members and attachment points on the curtain, and facilitates the use of commercially available components.

In an alternative embodiment of support members 10, an upper portion 37 of tube 15 of the support member structure, especially that portion that forms the angled overhead shield above a fence, may be hinged to the lower portion 38 with a locking hinge 39. The locking hinge connecting the upper and lower portions of tube 15 allows the angular relationship of the upper portion to the lower portion to be adjusted and locked in place. With portion 37 disposed at an angle to portion 38, the remaining length of support member 10, i.e., portion 38 of tube 15 and outer tube 12, may be disposed vertically behind the fence or other structure to be sprayed, avoiding the need to extend that lower portion of the support member outward from the fence. This alternative embodiment may be particularly useful when a structure to be sprayed is positioned very close to an adjacent structure, with insufficient clearance for placement of the preferred embodiment of the shield structure. Elastic cords 36 can be positioned to prevent rotation of the support members toward each other so as to loosen the connected portion of curtain 11. Alternatively, a generally U-shaped bracket 40 may be connected to tube 15 immediately below the hinge, to be placed over the top of a fence or other generally planar structure to be sprayed, to prevent rotation of the support members. In this alternative embodiment tube 15 would not telescope fully into tube 12, but the support member could be collapsed until the hinge, or bracket, reached the upper end of tube 12, and the hinged portion 37 of tube 15 then folded over to lie alongside tube 12, resulting in a collapsed length little, if any, longer than that of the preferred embodiment.

In another alternative embodiment, the upper ends 17 of tubes 15 may be adapted for attachment of separate angled curtain supports 41 to tubes 15 by a, e.g., threaded connection, so that support members 10 may be disposed vertically with the attached curtain supports 41 holding the attached curtain at an angle over the top of the fence to provide an overhead shield. If support members 10 can themselves be disposed at an angle, as described above, the curtain supports 41 need not be attached.

The foregoing description of preferred and alternative embodiments, and of variations in the structure, is intended to be illustrative and not limiting. Further alternative embodiments and variations may be made in the structure and method of use of the shield structure, all within the scope of the invention, in accordance with the following claims.

1. An overspray shield for protecting against the overspray of a sprayed material beyond and above the top of a structure against which the spray is directed, comprising,
a pair of adjustable support members, each including a first elongate hollow tube with a first end and an open second end, and a second elongate hollow tube with a first end and a second end, with said first end of said tube extending into said first tube from said second end of said first tube in telescoping relation therewith, a locking means disposed at said second end of said first tube for the purpose of releasably locking said second tube relative to said first tube, a first connector disposed on said second tube adjacent to said second end of said second tube, and a second connector means disposed on said second tube between said first connector and said first end of said second tube; and
a thin, flexible shield curtain of generally rectangular configuration, said shield curtain having an upper edge, an opposed lower edge, a first side edge, an opposed second side edge, a first corner at the intersection of said upper edge and said first side edge, and a second corner at the intersection of said upper edge and said second side edge, a first aperture disposed in said shield curtain at said first corner, a second aperture disposed in said shield curtain on said first side edge adjacent to said first aperture, a third aperture disposed in said shield curtain at said second corner, and a fourth aperture disposed in said shield curtain on said second side edge adjacent to said third aperture, with the spacing between said first aperture and said second aperture and the spacing between said third aperture and said fourth aperture approximately equal to the spacing between said first and second connector means of said support members, said shield curtain connected to said support members by connecting said first connector means of one of said support members to said first aperture, connecting said second connector means of said one of said support members to said second aperture, connecting said first connector means of the other of said support members to said third aperture, and connecting said second connector means of said other of said support members to said fourth aperture, such that an upper portion of said shield curtain is connected between said support members adjacent to said upper edge of said shield curtain, and a lower portion of said shield curtain between said second aperture and said fourth aperture and said lower edge of said shield curtain free from connection to said support members.

2. The overspray shield of claim 1, wherein said second tube of each of said support members includes a plurality of apertures through said second tube disposed in spaced relation between said first end and said second end of said second tube, said first tube includes an aperture penetrating said first tube adjacent to said second end thereof selectively alignable with each of said apertures in said second tube by telescoping said second tube relative to said first tube, and wherein said locking means of each of said support members comprises a locking assembly disposed at said second end of said first tube and connected thereto, each of said locking assemblies including a spring-biased pin extending through said aperture in said first tube to be received in a selected one of said apertures in said second tube aligned with said aperture in said first tube to releasably lock said second tube relative to said first tube.

3. The overspray shield of claim 1, wherein said second tube of each of said support members includes a first aperture extending through said second tube adjacent to said second end thereof and a second aperture extending through said second tube between said second end of said second tube and said first end of said second tube, and wherein each of said first and second connectors includes a D-clip having a pin that is extended through a respective one of said apertures in said second tube and a curved spring retainer pivotally connected to said pin for securing said pin within said aperture, and further includes a releasable snap connected to said D-clip for connection through a respective one of said apertures in said shield curtain so as to releasably connect said upper portion of said shield curtain to said support members.

4. The overspray shield of claim 2, wherein said second tube of each of said support members is non-circular in cross-sectional configuration, and wherein each of said locking assemblies further includes a generally annular guide ring with the same inside configuration as said cross-sectional configuration of said second tube, said guide ring preventing rotation of said second tube relative to said first tube.

5. The overspray shield of claim 1, wherein said shield curtain further includes a grommet connected to said shield curtain around each of said first, second, third, and fourth apertures in said shield curtain.

6. The overspray shield of claim 1, wherein each of said support members further includes a collar connected to said second end of said second tube thereof, and wherein said first connector is disposed on said collar.

7. The overspray shield of claim 6, wherein each of said collars is penetrated by a connector aperture, and wherein said first connector means of each of said support members includes a D-clip having a pin that is extended through said connector aperture in said collar, and a curved spring retainer pivotally connected to said pin for securing said pin within said connector aperture.

8. The overspray shield of claim 7, wherein said first connector means of each of said support members further includes a releasable snap connected to said D-clip for connection through a respective one of said first and third apertures in said shield curtain so as to releasably connect said first and second corners of said shield curtain to said support members.

9. The overspray shield of claim 1, wherein each of said second tubes of said support members includes an upper portion including said second end of said second tube, and a lower portion including said first end of said second tube, said upper portion pivotally connected to said lower portion, and wherein said first and second connector means are disposed on said upper portion of said second tube.

10. The overspray shield of claim 9, wherein each of said second tubes of said support members further includes an adjustable locking hinge, with said locking hinge forming said pivotal connection between said upper portion and said lower portion of each of said second tubes.

11. The overspray shield of claim 9, wherein each of said support members further includes a pair of brackets, each of said brackets connected to said lower portion of one of said second tubes adjacent to said pivotal connection between said upper portion and said lower portion of said second tube, for releasably connecting said support members to the top of the structure to be sprayed.

12. An overspray shield to be placed behind and extending above and slightly forward of a fence to be sprayed, for protecting against the overspray of a sprayed material beyond and above the top of the fence against which the spray is directed, comprising,
a pair of elongate adjustable support members, each including a first elongate hollow tube with a first end and an open second end, and a second elongate hollow tube with a first end and a second end, with said first end of said second tube extending into said first tube from said second end of said first tube in adjustable telescoping relation therewith; and
a thin, flexible shield curtain of generally rectangular configuration, said shield curtain having an upper edge, a lower edge opposite said upper edge, a first side edge, and a second side edge opposite said first side edge, said shield curtain connected to one of said second tubes of said support members along an upper portion of said first side edge adjacent to said upper edge, and said shield curtain connected to the other of said second tubes of said support members along an upper portion of said second side edge adjacent to said upper edge, the remainder of said shield curtain being without connection to said support members so as to hang freely between said support members.

13. The overspray shield of claim 12, wherein each of said second tubes of said support members includes an upper portion including said second end of said second tube and a lower portion including said first end of said second tube, with said upper portion pivotally connected to said lower portion, and wherein said shield curtain is connected to said upper portions of said second tubes.

14. The overspray shield of claim 12, wherein each of said support members further includes a curtain support connected to said second end of said second tube of said support member and extending outwardly therefrom at an angular relationship thereto, and wherein said shield curtain is connected to said curtain supports.

15. A method of shielding against overspray of sprayed material beyond, through, and over the top of a structure that extends substantially vertically from a supporting surface and horizontally along the supporting surface, the structure having a front side against which spray is to be directed, a back side, and a top, comprising the steps of,
providing a pair of elongate support members each including a first elongate hollow tube with a first end and an open second end, and a second elongate hollow tube with a first end and a second end, with said first end of said second tube extending into said first tube from said second end of said first tube in adjustable telescoping relation therewith;
providing a flexible shield curtain of generally rectangular configuration, said shield curtain having an upper edge, a lower edge opposite said upper edge, a first side edge, and a second side edge opposite said first side edge;
forming an overspray shield by connecting said shield curtain to one of said second tubes of said support members adjacent to said second end of said second tube, along an upper portion of said first side edge of said shield curtain adjacent to said upper edge, and connecting said shield curtain to the other of said second tubes of said support members adjacent to said second end of said second tube, along an upper portion of said second side edge of said shield curtain adjacent to said upper edge, a lower portion of said shield curtain between said upper portion and said bottom edge being without connection to said support members so as to hang freely between said support members;
positioning said overspray shield relative to the structure to be strayed with said support members in separated parallel relation to each other first ends of said first tubes of said support members resting on the supporting surface outward from the back side of the structure, with a portion of each of said second tubes of said support members extending over the top and upwardly above the front side of the structure at an angle relative to the front side of the structure, with said upper portion of said shield curtain extending between said portion of said second tubes extending over the top and upwardly above the front side of the structure so as to provide an overspray shield against spray directed upwardly of the top of the structure, and with said lower portion of said shield curtain hanging downwardly from said support members adjacent to and generally parallel to the back side of the structure so as to provide an overspray shield against spray passing through the structure and beyond the structure between said support members.

16. The method of claim 15, comprising the additional step of securing said upright support members to said structure so as to maintain said support members in generally parallel relationship.

17. The method of claim 15, wherein each of said second tubes of said support members includes an upper portion adjacent to said second end thereof and a lower portion between said upper portion and said first end of said second tube, with said upper portion pivotally connected to said lower portion, wherein said shield curtain is connected to said upper portions of said second tubes, wherein said upper portions of said second tubes are disposed at an angle relative to said lower portions of said second tubes, and wherein said overspray shield is positioned with said first tubes and said lower portions of said second tubes disposed substantially parallel to the back side of the structure, and with said upper portions of said second tubes and said upper portion of said shield curtain extending over and upwardly above the front side of the structure.

18. The method of claim 17, comprising the additional step of securing said upright support members to said structure so as to maintain said upper portions of said second tubes in generally parallel relationship.

19. The method of claim 15, wherein each of said support members further includes a curtain bracket connected to said second end of said second tube and extending outwardly and upwardly from said second tube at an angle relative thereto, wherein said upper portion of said shield curtain is connected to said curtain brackets, and wherein said overspray shield is positioned with said first tubes and said second tubes disposed substantially parallel to the back side of the structure, and with said curtain brackets and said upper portion of said shield curtain connected thereto extending over and upwardly above the front side of the structure.

20. The method of claim 19, comprising the additional step of securing said upright support members to said structure so as to maintain said curtain brackets in generally parallel relationship.
